(19) United States
(12) Patent Application Publication
(10) Pub. No.: US 2019/0079651 A1
(43) Pub. Date: Mar. 14, 2019

(54) CONTROL METHOD AND APPARATUS FOR SMART HOME

(71) Applicant: Gree Electric Appliances, Inc. of Zhuhai, Guangdong (CN)

(72) Inventor: Yang Li, Guangdong (CN)

(21) Appl. No.: 16/084,803

(22) PCT Filed: Mar. 17, 2017
(86) PCT No.: PCT/CN2017/077131

§ 371 Date: Sep. 13, 2018

(30) Foreign Application Priority Data
Mar. 17, 2016 (CN) 201610156964.4

(51) Int. Cl. G06F 3/0484; G01W 1/06; H04L 12/28

(52) U.S. Cl. CPC G06F 3/0484; G01W 1/06; G01W 2001/006; G01W 2203/00; H04L 12/2803

(57) ABSTRACT

Provided are a control method and apparatus for a smart home. The control method includes: acquiring the weather information of a region where a terminal is located, and acquiring state information of a target smart home from a smart home application, the smart home application being installed on the terminal; synchronously displaying the state information of the target smart home and the weather information on a screen of the terminal; receiving a trigger signal generated on the basis of the state information and the weather information; and generating a control signal on the basis of the trigger signal, the control signal to control an operation state of the target smart home by means of the smart home application.

### TECHNICAL FIELD

The present disclosure relates to the field of smart control, and more particularly to a control method and apparatus for a smart home.

### BACKGROUND

With the development of technology, the pace of people's life is accelerating, and it is no longer satisfied with the functions of existing applications. Most of the existing weather applications can only display weather-related data, and smart home applications can only achieve simple control. Since the control of smart homes is inseparable from the weather state, people usually need to learn about the latest weather conditions through media or weather applications, and then perform state control on smart homes, which will cause that the weather state information cannot be completely remembered, thus affecting the accuracy of smart home control. Moreover, it is necessary to acquire different information, the operation is complicated, and the control of smart homes is not convenient.

In view of the above problem in the conventional art of low control convenience of a smart home, no effective solution has been proposed yet.

### SUMMARY

The embodiment of the present disclosure provides a control method and apparatus for a smart home, intended to at least solve the technical problem in the conventional art of low control convenience of a smart home.

According to one aspect of the embodiment of the present disclosure, a control method for a smart home is provided. The control method includes: acquiring weather information of a region where a terminal is located, and acquiring state information of a target smart home from a smart home application installed on the terminal; synchronously displaying the state information of the target smart home and the weather information on a screen of the terminal; receiving a trigger signal generated on the basis of the state information and the weather information; and generating, according to the trigger signal, a control signal to control an operation state of the target smart home by means of the smart home application.

Further, receiving a trigger signal generated on the basis of the state information and the weather information includes: receiving a trigger signal acting on a switch button, wherein switch buttons corresponding to the state information and the weather information are disposed in the screen of the terminal.

Further, before acquiring the state information of a target smart home from a smart home application, the control method further includes: determining the target smart home in a smart home list, wherein multiple smart homes are recorded in the smart home list, and each smart home in the multiple smart homes is associated with the smart home application.

Further, determining the target smart home in a smart home list includes: displaying an application page of a weather application on the screen of the terminal, a synchronous start button being disposed on the application page; if it is detected that the synchronous start button is pressed, generating a synchronous start instruction to acquire the smart home list of the smart home application; and determining the selected target smart home in the smart home list.

Further, determining the target smart home in a smart home list includes: acquiring the smart home list of the smart home application after the weather application is started; and determining multiple smart homes recorded in the smart home list as the target smart homes.

Further, synchronously displaying the state information of the target smart home and the weather information on a screen of the terminal includes: displaying the state information in a first region on the screen of the terminal, and displaying the weather information in a second region on the screen of the terminal.

Further, a management button corresponding to the target smart home is also disposed in the first region, and after synchronously displaying the state information of the target smart home and the weather information on a screen of the terminal, the control method further includes: if it is detected that the management button is pressed, jumping to a management binding home page, wherein the management binding home page is provided with a binding management button for modifying a synchronization state of the target smart home, the modification including initiating synchronization or canceling synchronization; and when it is detected that the binding management button is pressed, executing an operation, indicated by the binding management button, of modifying the synchronization state of the target smart home.

Further, receiving a trigger signal generated on the basis of the state information and the weather information includes: when it is detected that the state information of the target smart home is operated, determining that the trigger signal generated in response to the operation is received; and generating a control signal on the basis of the trigger signal includes: entering a device page of the target smart home in response to the trigger signal, and the device page being provided with a plurality of working mode buttons; and when the working mode buttons are triggered, generating the control signals corresponding to the working mode buttons.

According to another aspect of the embodiment of the present disclosure, a control apparatus for a smart home is also generated. The control apparatus includes: an acquisition unit, configured to acquire weather information of a region where a terminal is located, and acquire state information of a target smart home from a smart home application, the smart home application being installed on the terminal; a display unit, configured to synchronously display the state information of the target smart home and the weather information on a screen of the terminal; a receiving unit, configured to receive a trigger signal generated on the basis of the state information and the weather information; and a generation unit, configured to generate a control signal on the basis of the trigger signal, the control signal to control an operation state of the target smart home by means of the smart home application.

Further, the receiving unit includes: a receiving module, configured to receive a trigger signal acting on a switch button, wherein switch buttons corresponding to the state information and the weather information are disposed in the screen of the terminal.

Further, the control apparatus further includes: a determination unit, configured to determine, before acquiring state information of a target smart home from a smart home application, the target smart home in a smart home list, wherein multiple smart homes are recorded in the smart home list, and each smart home in the multiple smart homes is associated with the smart home application.

Further, the determination unit includes: a display module, configured to display an application page of a weather application on the screen of the terminal, a synchronous start button being disposed on the application page; an instruction generation module, configured to generate a synchronous start instruction, if it is detected that the synchronous start button is pressed, the synchronous start instruction being used to acquire the smart home list of the smart home application; and a first determination module, configured to determine the selected target smart home in the smart home list.

Further, the determination unit includes: an acquisition module, configured to acquire a smart home list of the smart home application, after the weather application is started; and a second determination module, configured to determine multiple smart homes recorded in the smart home list as the target smart home.

Further, the display unit includes: an information display module, configured to display the state information in a first region on the screen of the terminal, and display the weather information in a second region on the screen of the terminal.

Further, a management button corresponding to the target smart home is also disposed in the first region, and the control apparatus further includes: a jumping module, configured to jump to a management binding home page if it is detected that the management button is pressed, after synchronously displaying the state information of the target smart home and the weather information on a screen of the terminal, wherein the management binding home page is provided with a binding management button for modifying a synchronization state of the target smart home, the modification including initiating synchronization or canceling synchronization; and an execution module, configured to execute an operation of modifying the synchronization state of the target smart home that indicated by the binding management button, when it is detected that the binding management button is pressed.

Further, the receiving unit is configured to determine that the trigger signal generated in response to the operation is received, when it is detected that the state information of the target smart home is operated; the generation unit includes: an entry module, configured to enter a device page of the target smart home, in response to the trigger signal, wherein the device page is provided with multiple working mode buttons; and a signal generation module, configured to generate the control signals corresponding to the working mode buttons, when the working mode buttons are triggered.

In the embodiment of the present disclosure, after acquiring weather information of a region where a terminal is located and acquiring the state information of a target smart home, from a smart home application, the terminal synchronously displays the acquired state information of the target smart home and the acquired weather information on a screen of the terminal, and when a trigger signal is received, an operation state of the target smart home can be controlled by means of the smart home application. By means of the above embodiment, the terminal may synchronously displays the state information of the target smart home and the weather information, and quickly controls the operating state of the target smart home on the same page on the basis of the weather information. Compared with the conventional art where it is necessary to first acquire weather information and then open a smart home application to perform smart home control, the present disclosure achieves the technical effects of quickly controlling a target smart home and improving the control convenience of a smart home, and solves the technical problem in the conventional art of low control convenience of a smart home.

### BRIEF DESCRIPTION OF THE DRAWINGS

The drawings described herein are used to provide a further understanding of the present disclosure, and constitute a part of the present application. The exemplary embodiments of the present disclosure and descriptions thereof are used to explain the present disclosure, and do not constitute improper limitations to the present disclosure. In the drawing:

FIG. 1 is a flowchart of a control method for a smart home according to an embodiment of the present disclosure;

FIG. 2 is a schematic diagram of an alternative terminal page adopting a control method for a smart home according to an embodiment of the present disclosure;

FIG. 3 is a schematic diagram of another alternative terminal page adopting a control method for a smart home according to an embodiment of the present disclosure;

FIG. 4 is a schematic diagram of yet another alternative terminal page adopting a control method for a smart home according to an embodiment of the present disclosure; and

FIG. 5 is a schematic diagram of a control apparatus for a smart home according to an embodiment of the present disclosure.

### DETAILED DESCRIPTION OF THE EMBODIMENTS

In order to make those skilled in the art better understand the solution of the present disclosure, the technical solution in the embodiments of the present disclosure will be clearly and completely described hereinbelow with reference to the drawings in the embodiments of the present disclosure. It is apparent that the described embodiments are only a part of the embodiments of the present disclosure, not all of the embodiments. On the basis of the embodiments of the present disclosure, all other embodiments obtained on the premise of no creative work of those of ordinary skill in the art shall fall within the scope of protection of the present disclosure.

It is to be noted that the specification and claims of the present disclosure and terms “first”, “second” and the like in the drawings are intended to distinguish similar objects, and do not need to describe a specific sequence or a precedence order. It should be understood that objects used in such a way may be exchanged under appropriate conditions, in order that the embodiments of the present disclosure described here can be implemented in a sequence except sequences graphically shown or described here. In addition, terms “include” and “have” and any variations thereof are intended to cover non-exclusive inclusions. For example, processes, methods, systems, products or devices containing a series of steps or units do not need to clearly show those steps or units, and may include other inherent steps or units of these processes, methods, products or devices, which are not clearly shown.

According to the embodiment of the present disclosure, an embodiment of a control method for a smart home is provided. It is to be noted that the steps illustrated in the flowchart of the drawings may be executed in a computer system such as a set of computer executable instructions, and although the logical order is shown in the flowchart, in some cases, the steps shown or described may be performed in an order different from the order herein.

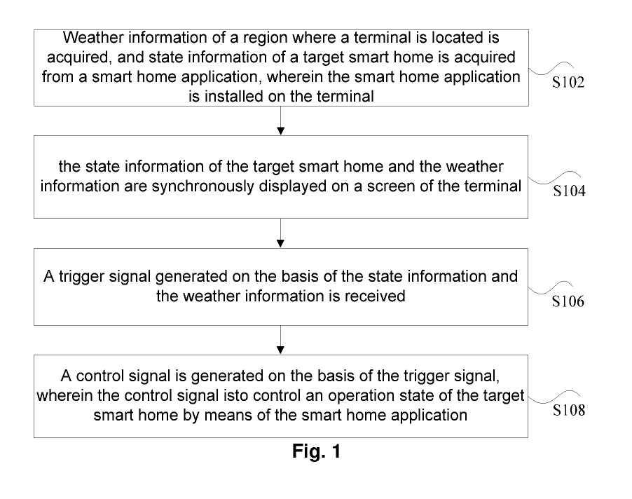

FIG. 1 is a flowchart of a control method for a smart home according to an embodiment of the present disclosure. As shown in FIG. 1, the control method includes the steps as follows.

At S102, weather information of a region where a terminal is located is acquired, and state information of a target smart home is acquired from a smart home application, wherein the smart home application is installed on the terminal.

At S104, the state information of the target smart home and the weather information are synchronously displayed on a screen of the terminal.

At S106, a trigger signal generated on the basis of the state information and the weather information is received.

At S108, a control signal is generated on the basis of the trigger signal, wherein the control signal is to control an operation state of the target smart home by means of the smart home application.

By means of the present disclosure, after acquiring weather information of a region where a terminal is located and acquiring state information of a target smart home from a smart home application, the terminal synchronously displays the acquired state information of the target smart home and the acquired weather information on a screen of the terminal, and when a trigger signal is received, an operation state of the target smart home can be controlled by means of the smart home application. By means of the above embodiment, the terminal may synchronously displays the state information of the target smart home and the weather information, and quickly controls the operating state of the target smart home on the same page on the basis of the weather information. Compared with the conventional art where it is necessary to first acquire weather information and then open a smart home application to perform smart home control, the present disclosure achieves the technical effects of quickly controlling a target smart home and improving the control convenience of a smart home, and solves the technical problem in the conventional art of low control convenience of a smart home.

Specifically, the terminal in the above embodiment may be a mobile terminal, such as a mobile phone, a computer, or a remote controller. The smart home may include household devices such as an air conditioner, a dehumidifier, a humidifier, an air purifier, a washing machine, a range hood and so on. The smart home may be connected to a smart home application and controlled by the smart home application. The state information of the smart home is used to indicate information such as the turn on and off of the smart home, an operation mode, and the state of various internal components. The state information of the smart home such as the air conditioner may include: information such as operating, a cooling mode, and a current indoor temperature 25° C. The weather information may include weather state information of a region where the terminal is located, such as air quality information, health value information, body temperature, comfort, temperature, humidity, and appropriate values. After receiving a trigger signal of a switch button on the screen of the terminal, the terminal may send a control signal to the smart home application, and control the smart home application to control an operating state of a target smart home bound to the application, and the operating state may include states such as turn on, turn off, and adjustment of an operating mode, an operating speed, voltage and current.

Alternatively, the step of receiving a trigger signal generated on the basis of the state information and the weather information includes: receiving a trigger signal acting on a switch button, wherein switch buttons corresponding to the state information and the weather information are disposed in the screen of the terminal.

The manner of acting on the switch button in the above embodiment may be single click, double click, slide, or the like.

Further alternatively, a preset region in the screen of the terminal includes a switch button for controlling turn on or off of the target smart home, a trigger signal acting on the switch button is received, and a control signal for controlling turn on or off of the target smart home is sent to the smart home application.

In the above embodiment, after the connection between the weather application and the smart home application is established, a page of the weather application (i.e., within the preset region on the screen of the terminal) receives the trigger signal acting on the switch button, and the turn on or off of the target smart home may be controlled through the smart home application. Through the above embodiment, the effect of quickly controlling the smart home can be achieved, and the target smart home can be directly controlled by the weather application without opening the smart home application, thereby increased the convenience of control.

Alternatively, before acquiring state information of a target smart home from a smart home application, the control method further includes: determining the target smart home in a smart home list, wherein multiple smart homes are recorded in the smart home list, and each smart home in the multiple smart homes is associated with the smart home application.

In the above embodiment, the target smart home in the smart home list is first determined, then the state information of the target smart home is acquired from the smart home application, the weather information and the state information of the target smart home are simultaneously displayed on the screen of the terminal, and the smart home is controlled according to the trigger signal. Through the above embodiment, the target smart home in a display state needing to be synchronized is displayed by filtering out the invalid smart home state information, thereby improving the rate of information acquiring and achieving the effect of quickly and accurately acquiring the state information of the target smart home.

In an alternative embodiment, the step of determining the target smart home in a smart home list includes: displaying an application page of a weather application on the screen of the terminal, a synchronous start button being disposed on the application page; if it is detected that the synchronous start button is pressed, generating a synchronous start instruction, the synchronous start instruction being used to acquire the smart home list of the smart home application; and determining the selected target smart home in the smart home list.

In the above embodiment, when an application page of the weather application is displayed on the screen of the terminal, if it is detected that the button on the application page is pressed, the smart home list of the smart home application is acquired, and the target smart home is determined from the list to acquire the state information of the target smart home. Meanwhile, the weather information is acquired, the state information of the target smart home and the weather information are synchronously displayed on the screen, and the operating state of the target smart home is controlled after the control signal is received. Through the above embodiment, the target smart home is determined through the smart home list that can be acquired through a synchronous start button on the weather application page, thereby achieving the effect of simplifying the operation steps of the target smart home.

In an alternative embodiment, the step of determining the target smart home in a smart home list includes: after the weather application is started, acquiring a smart home list of the smart home application; and determining multiple smart homes recorded in the smart home list as the target smart homes.

In the above embodiment, all smart homes bound to the smart home application may be automatically determined as the target smart homes, that is, the function of manually synchronizing devices by a user can be cancelled. The connected devices such as the air conditioner, the dehumidifier, the humidifier and the air purifier in the smart home may be automatically synchronized to the weather module. In the case that the user has multiple devices, the area occupied by the weather module will be relatively large, and the proportion in the weather application will be too large. The convenience brought by the automatic connection to control the smart home will be weakened.

Alternatively, the step of synchronously displaying the state information of the target smart home and the weather information on a screen of the terminal includes: displaying the state information in a first region on the screen of the terminal, and displaying the weather information in a second region on the screen of the terminal.

In the above embodiment, the state information of the target smart home and the weather information are separately and synchronously displayed in the first region and the second region on the screen of the terminal, so as to achieve a comprehensive understanding of the weather information and the operating state of the smart home by a terminal operator.

In the above alternative embodiment, a management button corresponding to the target smart home is also disposed in the first region, and after synchronously displaying the state information of the target smart home and the weather information on a screen of the terminal, the control method further includes: if it is detected that the management button is pressed, jumping to a management binding home page, wherein the management binding home page is provided with a binding management button for modifying a synchronization state of the target smart home, the modification including initiating synchronization or canceling synchronization; and when it is detected that the binding management button is pressed, executing an operation of modifying the synchronization state of the target smart home which indicated by the binding management button.

The first region on the screen of the terminal in the above embodiment can record the state information of the smart home, and can also be provided with a management button corresponding to the target smart home. By pressing the management button, binding management for the synchronization state of the smart home can be realized. That is, the synchronous display of the state information of the target smart home and the weather information may be initiated through the management button, and the synchronous display of the state information of the target smart home and the weather information may be cancelled through the management button. Through the above embodiments, the binding state of the target smart home may be flexibly controlled, and the comfort of user experience can be improved.

Alternatively, the step of receiving a trigger signal generated on the basis of the state information and the weather information includes: when it is detected that the state information of the target smart home is operated, determining that the trigger signal generated in response to the operation is received; and generating a control signal on the basis of the trigger signal includes: entering a device page of the target smart home in response to the trigger signal, wherein the device page is provided with multiple working mode buttons; and generating the control signals corresponding to the working mode buttons when the working mode buttons are triggered.

In the above embodiment, after the state information and the weather information are synchronously displayed on the screen of the terminal, if it is detected that the state information of the target smart home is operated, a device page of the target smart home may be entered, and the working mode of the target smart home is more deeply controlled or adjusted through a working mode button on the device page. Through the above embodiment, a management binding electrical appliance page may be opened by the management button to implement rapid change or cancellation of the binding state of the target smart home, thereby achieving the effect of flexible and efficient management of the target smart home.

The operations of the above embodiment may include single click, double click, pressing, and slide, etc. The above working mode may include various working modes of different smart homes. For example, when the target smart home is an air conditioner, the above working mode may include a cooling mode, a heating mode, a ventilation mode, a dehumidification mode, an automatic mode, and the like. When the target smart home is an air purifier, the above working mode may include an automatic mode, a large air volume mode, a small air volume mode, and the like.

Alternatively, before acquiring weather information of a region where a terminal is located and acquiring the state information of a target smart home from a smart home application, the control method includes: establishing a connection between a weather application and a smart home application, wherein the smart home application is an application program for controlling the target smart home, and the weather application is an application program for detecting and displaying the weather information.

In the above embodiment, the weather application and the smart home application are connected, and the weather information and the operating state of the target smart home are displayed together, thereby achieving the effects of interconnection of two different application programs, information synchronization between the two different applications, and quick connection and operation.

Specifically, a mobile phone (i.e., the terminal mentioned above) is taken as an example. A weather application and a smart home application may be installed on the mobile phone. The weather application is used to detect and display weather information of a city where the mobile phone is located, and the smart home application may control an operating state such as turn on or off of a target smart home. The weather application first establishes a connection with the smart home application. After the connection is established, the weather application page of the mobile phone may synchronously display the weather information and the operating state information of the target smart home, the mobile phone or the user of the mobile phone may control the operating state of the target smart home according to the weather information. The control method is implemented based on a weather application operation page. Specifically, the smart home application connected with the weather application is used to control the target smart home.

Through the above embodiment, the user may quickly turn on or off corresponding home appliances according to the weather information, thereby improving the convenience of the user operation.

Alternatively, the preset region includes a device list of the target smart home, and the step of receiving the trigger signal in the preset region on the screen of the terminal includes: receiving a trigger signal acting on the device list; and the step of sending a control signal to the smart home application includes: sending a control signal for controlling a preset module page in the weather application, wherein the preset module page is a module for controlling the target smart home.

In the above embodiment, when a more complicated operation is required on the target smart home, the preset module page in the weather application (such as a control page of the corresponding target smart home in the smart home application) may be opened by a trigger signal of the device list in the preset region on the screen of the terminal, so as to achieve a more complicated operation on the selected target smart home, thereby achieving the technical effect of more comprehensively and effectively controlling the target smart home.

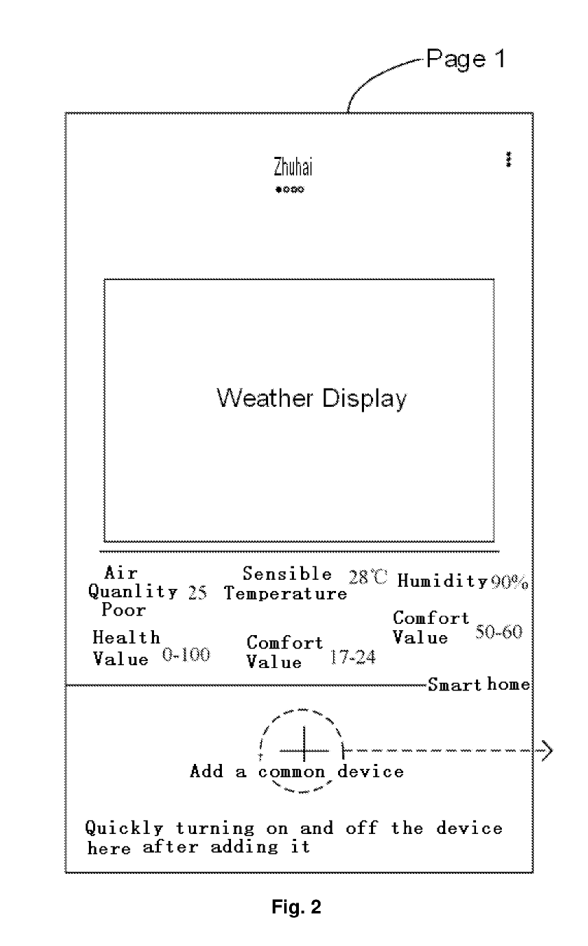

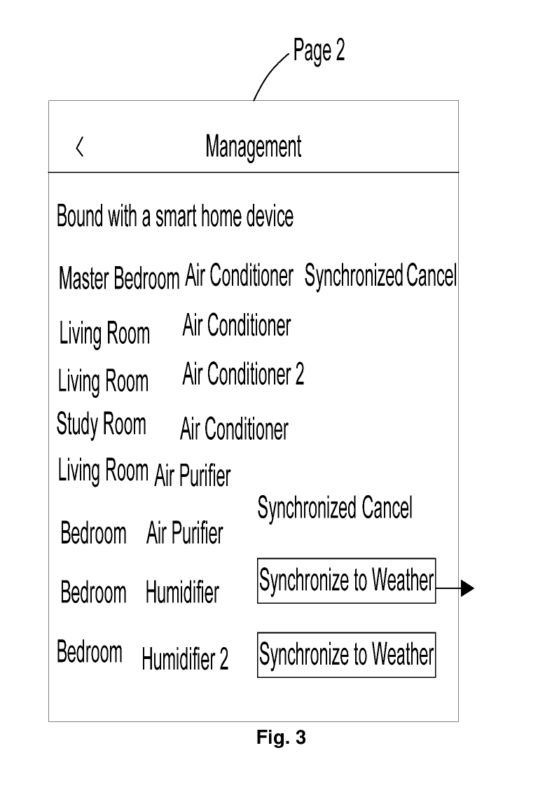

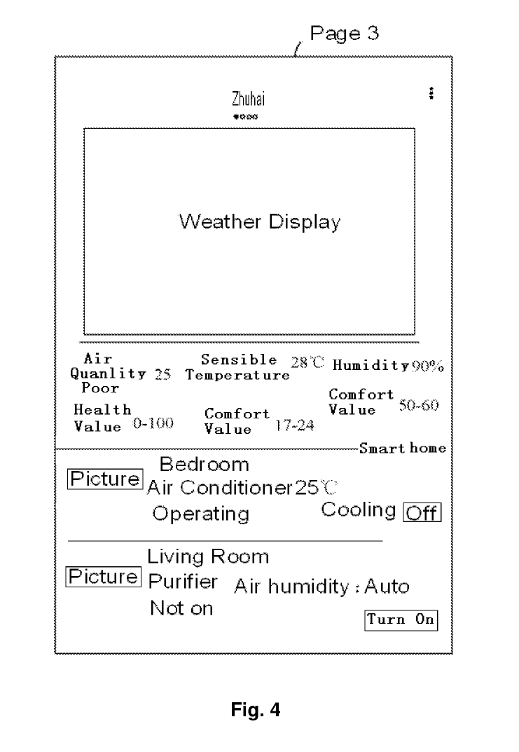

As shown in FIG. 2 to FIG. 4, Page 1 in FIG. 2 is a page where no smart home is added, Page 2 in FIG. 3 is a page for managing and binding a smart home, and Page 3 in FIG. 4 is a page added with a smart home.

Page 1 shown in FIG. 2 is an application page of a weather application. Before the smart home is added, the page of the weather application includes the name of a region where the terminal is located, such as “Zhuhai” in FIG. 2. The following is a “Weather Display” sub-page for displaying weather conditions, including weather conditions such as “Air Quality Poor 125”, “Health Value 0-100”, “Sensible Temperature 28° C.”, “Comfort Value 17-24”, “Humidity 90%”, and “Appropriate value 50-60”. The above display region of the weather information about the region and weather conditions is the second region in the above embodiment, and the bottom part is the region of the smart home module, that is, the first region in the above embodiment, for “Add a common device” and “Quickly turn on and off the device here after adding it”. The circle with a cross in the middle of Page 1 in FIG. 2 indicates a synchronous start button in the above embodiment. If it is detected that the synchronous start button is pressed, a synchronous start instruction is generated, the synchronous start instruction being used to acquire a smart home list of the smart home application. The smart home list is shown as Page 2 in FIG. 3. The arrow in FIG. 2 indicates a flow direction, that is, after pressing the synchronous start button, Page 1 will jump to Page 2 shown in FIG. 3.

Page 2 of FIG. 3 is a management binding electrical appliance page, which includes a smart home list, and specifically includes a page title “Management” and “Bound with a smart home device”. It specifically includes the following devices: “Air Conditioner” located in “Master Bedroom”, “Air Conditioner” located in “Living Room”, “Air Conditioner 2” located in “Living Room”, “Air Conditioner” located in “Study Room”, “Air Purifier” located in “Living Room”, “Humidifier” located in “Bedroom”, and “Humidifier 2” located in “Bedroom”. The right side of the line where these devices are located shows the binding state of the device (i.e., smart home) and the smart home application, mainly including “Synchronized”, “Cancel” and “Synchronize to Weather”. The arrow in FIG. 3 indicates that after operating the “Synchronize to Weather” button, Page 2 will jump to Page 3 as shown in FIG. 4.

Page 3 of FIG. 4 is a page added with a smart home. Page 3 is basically the same as the display of the second region in Page 1, except that the region of the bottommost smart home module in Page 3 (i.e., the first region) changes to: display a smart home picture, a smart home name, a location, an operating mode state, and a button for controlling on and off. For example, the page of the smart home module may include: “Bedroom, Air Conditioner, 25° C., Cooling, Operating” and “Off” button, which indicates that the air conditioner in the bedroom is in a cooling operation with a cooling temperature of 25° C. and the air conditioner may be turned off by a corresponding “Off” button. The page of the smart home module may also include “Living Room, Purifier, Wind speed: Automatic, Not On” and “On” button, which indicates that the wind speed of the purifier located in the living room is automatic in the non-on state and the purifier may be controlled to be turned on by the “On” button, wherein the smart home in the page of the smart home module is a device that is bound to the smart home application, as shown in Page 2, that is, the bound target smart home. The first region in Page 3 is also provided with a management button corresponding to the target smart home, such as the “Management” button in FIG. 4. If it is detected that the management button is pressed, it jumps to the management binding home page.

In an alternative embodiment, the module is used for the first time (i.e., the smart home module in the weather application described above): no binding device is displayed, a user may click on a button for adding a device (“Add a Common Device” button in Page 1 of FIG. 2, that is, a synchronous start button) to enter a management binding electrical appliance page (i.e., Page 2), which displays the devices such as an air conditioner, a dehumidifier, a humidifier and an air purifier having been connected to the smart home. Then, the button for synchronizing the device (“Synchronize to Weather” button in Page 2 of FIG. 3) may be selected, thereby being able to synchronize to the weather application.

When using this module again (i.e., the smart home module in the above weather application): it can display a device that the user has bound (such as “Air Conditioner” and “Purifier” in Page 3 of FIG. 4), and display the current state of the device synchronously. The user can quickly switch the device through the “On” and “Off” buttons, and can also click on the device list to quickly enter the smart home page of the device to achieve more complicated operating state adjustment. Or, the user can click on the “Management” text (i.e., the Management button) in Page 3 in FIG. 4 to enter the management binding electrical appliance page to change or cancel the device synchronized to the weather.

Alternatively, the operation of clicking the device list to enter the smart home page of the device may be canceled, and only the button function of quickly turning on and off the device is retained. But users who want to change the device mode need to open the smart home application for further control.

It is to be noted that if the target smart home is in the opening state, device synchronization is cancelled in the management binding electrical application page of the weather application, the device may also keep open, but the information of the device will not be displayed again in the weather application, and the quick operation of turning on and off the device cannot be performed any longer. In the above embodiment, the device may also be switched off or on through the smart home application.

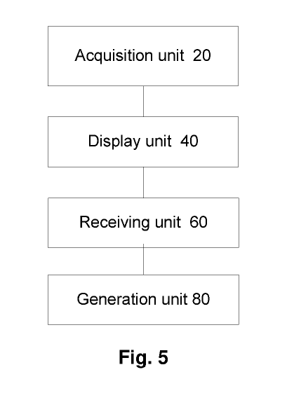

According to another aspect of the embodiment of the present disclosure, a control apparatus for a smart home is provided. As shown in FIG. 5, the control apparatus includes: an acquisition unit 20, a display unit 40, a receiving unit 60, and a generation unit 80.

The acquisition unit 20 is configured to acquire weather information of a region where a terminal is located, and acquire the state information of a target smart home from a smart home application, the smart home application being installed on the terminal.

The display unit 40 is configured to synchronously display the state information of the target smart home and the weather information on a screen of the terminal.

The receiving unit 60 is configured to receive a trigger signal generated on the basis of the state information and the weather information.

The generation unit 80 is configured to generate a control signal on the basis of the trigger signal, the control signal being used for controlling an operation state of the target smart home by means of the smart home application.

By means of the above embodiment of the present disclosure, after acquiring weather information of a region where a terminal is located and acquiring the state information of a target smart home from a smart home application, the terminal synchronously displays the acquired state information of the target smart home and the acquired weather information on a screen of the terminal, and when a trigger signal is received, an operation state of the target smart home can be controlled by means of the smart home application. By means of the above embodiment, the terminal may synchronously displays the state information of the target smart home and the weather information, and quickly controls the operating state of the target smart home on the same page on the basis of the weather information. Compared with the conventional art where it is necessary to first acquire weather information and then open a smart home application to perform smart home control, the present disclosure achieves the technical effects of quickly controlling a target smart home and improving the control convenience of a smart home, and solves the technical problem in the conventional art of low control convenience of a smart home.

Alternatively, the receiving unit 60 includes: a receiving module, configured to receive a trigger signal acting on a switch button, wherein switch buttons corresponding to the state information and the weather information are disposed in the screen of the terminal.

In the above embodiment, after the connection between the weather application and the smart home application is established, a page of the weather application (i.e., within the preset region on the screen of the terminal) receives the trigger signal acting on the switch button, and the turn on or off of the target smart home may be controlled through the smart home application. Through the above embodiment, the effect of quickly controlling the smart home can be achieved, and the target smart home can be directly controlled by the weather application without opening the smart home application, thereby improving the convenience of control.

Alternatively, the control apparatus further includes: a determination unit, configured to determine before acquiring state information of a target smart home from a smart home application, the target smart home in a smart home list, wherein multiple smart homes are recorded in the smart home list, and each smart home in the multiple smart homes is associated with the smart home application.

In the above embodiment, the target smart home in the smart home list is first determined, then the state information of the target smart home is acquired from the smart home application, the weather information and the state information of the target smart home are simultaneously displayed on the screen of the terminal, and the smart home is controlled according to the trigger signal. Through the above embodiment, the target smart home in a display state needing to be synchronized is displayed by filtering out the invalid smart home state information, thereby improving the rate of information acquiring and achieving the effect of quickly and accurately acquiring the state information of the target smart home.

Alternatively, the determination unit includes: a display module, configured to display an application page of a weather application on the screen of the terminal, a synchronous start button being disposed on the application page; an instruction generation module, configured to generate a synchronous start instruction, if it is detected that the synchronous start button is pressed, the synchronous start instruction being used to acquire the smart home list of the smart home application; and a first determination module, configured to determine the selected target smart home in the smart home list.

In the above embodiment, when an application page of the weather application is displayed on the screen of the terminal, if it is detected that the button on the application page is pressed, the smart home list of the smart home application is acquired, and the target smart home is determined from the list to acquire the state information of the target smart home. Meanwhile, the weather information is acquired, the state information of the target smart home and the weather information are synchronously displayed on the screen, and the operating state of the target smart home is controlled after the control signal is received. Through the above embodiment, the smart home list may be acquired through a synchronous start button on the weather application page to determine the target smart home, thereby achieving the effect of simplifying the operation steps of the target smart home.

Alternatively, the determination unit includes: an acquisition module, configured to acquire a smart home list of the smart home application after the weather application is started; and a second determination module, configured to determine multiple smart homes recorded in the smart home list as the target smart home.

In the above embodiment, all smart homes bound to the smart home application may be automatically determined as the target smart home, that is, the function of manually synchronizing devices by a user may be cancelled. The connected devices such as the air conditioner, the dehumidifier, the humidifier and the air purifier in the smart home may be automatically synchronized to the weather module. In the case that the user has multiple devices, the area occupied by the module will be relatively large, and the proportion in the weather application will be too large. The convenience brought by the automatic connection to control the smart home will be weakened.

Alternatively, the display unit 40 includes: an information display module, configured to display the state information in a first region on the screen of the terminal, and display the weather information in a second region on the screen of the terminal.

In the above embodiment, the state information of the target smart home and the weather information are separately and synchronously displayed in the first region and the second region on the screen of the terminal, so as to achieve a comprehensive understanding of the weather information and the operating state of the smart home by a terminal operator.

Alternatively, a management button corresponding to the target smart home is also disposed in the first region, and the control apparatus further includes: a jumping module, configured to jump to a management binding home page if it is detected that the management button is pressed after synchronously displaying the state information of the target smart home and the weather information on a screen of the terminal, wherein the management binding home page is provided with a binding management button for modifying a synchronization state of the target smart home, the modification including initiating synchronization or canceling synchronization; and an execution module, configured to execute an operation of modifying the synchronization state of the target smart home that indicated by the binding management button, when it is detected that the binding management button is pressed.

The first region on the screen of the terminal in the above embodiment can record the state information of the smart home, and can also be provided with a management button corresponding to the target smart home. By pressing the management button, binding management for the synchronization state of the smart home can be realized. That is, the synchronous display of the state information of the target smart home and the weather information may be initiated through the management button, and the synchronous display of the state information of the target smart home and the weather information may be cancelled through the management button. Through the above embodiments, the binding state of the target smart home may be flexibly controlled, and the user experience comfort is improved.

Alternatively, the receiving unit 60 is configured to determine that the trigger signal generated in response to the operation is received, when it is detected that the state information of the target smart home is operated; the generation unit 80 includes: an entry module, configured to enter a device page of the target smart home in response to the trigger signal, wherein the device page is provided with multiple working mode buttons; and a signal generation module, configured to generate the control signals corresponding to the working mode buttons, when the working mode buttons are triggered.

In the above embodiment, after the state information and the weather information are synchronously displayed on the screen of the terminal, if it is detected that the state information of the target smart home is operated, a device page of the target smart home may be entered, and the working mode of the target smart home is more deeply controlled or adjusted through a working mode button on the device page. Through the above embodiment, a management binding electrical appliance page may be opened by the management button to implement rapid change or cancellation of the binding state of the target smart home, thereby achieving the effect of flexible and efficient management of the target smart home.

In the above embodiment, a user can manually cancel device synchronization between the weather application and the smart home application. The connected devices such as the air conditioner, the dehumidifier, the humidifier and the air purifier in the smart home may be automatically synchronized to the weather module. In the case that the user has multiple devices, the area occupied by the module will be relatively large, and the proportion in the weather application will be too large. The convenience brought by the automatic connection to control the smart home will be weakened.

Through the above embodiment, the weather application is associated with the smart home application, the synchronized smart home is quickly turned on or off through the module in the weather application, and the operating state of the smart home is displayed. The user may quickly turn on or off corresponding home appliances according to the weather information, thereby improving the convenience of the user operation.

The serial numbers of the embodiments of the present disclosure are only used for descriptions, and do not represent the preference of the embodiments.

In the above embodiments of the present disclosure, descriptions of each embodiment are emphasized respectively, and parts which are not elaborated in detail in a certain embodiment may refer to relevant descriptions of other embodiments.

In some embodiments provided by the present disclosure, it will be appreciated that the disclosed technical contents may be implemented in other modes, wherein the apparatus embodiment described above is only schematic. For example, division of the units may be division of logical functions, and there may be additional division modes during actual implementation. For example, a plurality of units or components may be combined or integrated to another system, or some features may be omitted or may be not executed. In addition, displayed or discussed mutual coupling or direct coupling or communication connection may be performed via some interfaces, and indirect coupling or communication connection between units or modules may be in an electrical form or other forms.

The units illustrated as separate parts may be or may not be physically separated. Parts for unit display may be or may not be physical units. That is, the parts may be located at a place or may be distributed on a plurality of units. The aims of the solutions of the embodiments may be achieved by selecting some or all units according to actual requirements.

In addition, all function units in all embodiments of the present disclosure may be integrated in a processing unit, or each unit may exist separately and physically, or two or more units may be integrated in a unit. The integrated unit may be implemented in a hardware form or may be implemented in a software function unit form.

If being implemented in a form of software function module and sold or used as an independent product, the integrated unit may also be stored in a computer-readable storage medium. Based on such understanding, the essence of the technical solutions of the embodiment of the present disclosure or parts making contribution to the conventional art may be embodied in a form of software product, and the computer software product is stored in a storage medium, including a plurality of instructions used to enable a computer device (which may be a personal computer, a server, a network device or the like) to execute all or part of the method in each embodiment of the present disclosure. The foregoing storage medium includes: various media capable of storing program codes such as a U disk, a Read-Only Memory (ROM), a Random Access Memory (RAM), a mobile hard disk, a magnetic disk or an optical disk.

The above is only preferred implementation modes of the present disclosure. It should be pointed out that those of ordinary skill in the art may also make some improvements and modifications without departing from the principle of the present disclosure. These improvements and modifications should fall within the scope of protection of the present disclosure.

What is claimed is:

1. A control method for a smart home, comprising:
acquiring weather information of a region where a terminal is located, and acquiring state information of a target smart home from a smart home application installed on the terminal;
synchronously displaying the state information of the target smart home and the weather information on a screen of the terminal;
receiving a trigger signal generated on the basis of the state information and the weather information; and
generating, according to the trigger signal, a control signal to control an operation state of the target smart home by means of the smart home application.

2. The control method as claimed in claim 1, wherein receiving a trigger signal generated on the basis of the state information and the weather information comprises:
receiving a trigger signal acting on a switch button, switch buttons corresponding to the state information and the weather information being disposed in the screen of the terminal.

3. The control method as claimed in claim 1, wherein before acquiring the state information of a target smart home from a smart home application, the control method further comprises:
determining the target smart home in a smart home list, a plurality of smart homes being recorded in the smart home list, each smart home in the plurality of smart homes being associated with the smart home application.

4. The control method as claimed in claim 3, wherein determining the target smart home in a smart home list comprises:
displaying an application page of a weather application on the screen of the terminal, a synchronous start button being disposed on the application page;
if it is detected that the synchronous start button is pressed, generating a synchronous start instruction to acquire the smart home list of the smart home application; and
determining the selected target smart home in the smart home list.

5. The control method as claimed in claim 3, wherein determining the target smart home in a smart home list comprises:
acquiring the smart home list of the smart home application after the weather application is started; and
determining a plurality of smart homes recorded in the smart home list as the target smart homes.

6. The control method as claimed in claim 1, wherein synchronously displaying the state information of the target smart home and the weather information on a screen of the terminal comprises:
displaying the state information in a first region on the screen of the terminal, and displaying the weather information in a second region on the screen of the terminal.

7. The control method as claimed in claim 6, wherein a management button corresponding to the target smart home is also disposed in the first region, and after synchronously displaying the state information of the target smart home and the weather information on a screen of the terminal, the control method further comprises:
if it is detected that the management button is pressed, jumping to a management binding home page, the management binding home page being provided with a binding management button for modifying a synchronization state of the target smart home, the modification comprising initiating synchronization or canceling synchronization; and
when it is detected that the binding management button is pressed, executing an operation, indicated by the binding management button, of modifying the synchronization state of the target smart home.

8. The control method as claimed in claim 1, wherein
receiving a trigger signal generated on the basis of the state information and the weather information comprises: when it is detected that the state information of the target smart home is operated, determining that the trigger signal generated in response to the operation is received; and
generating a control signal on the basis of the trigger signal comprises:
entering a device page of the target smart home in response to the trigger signal, and the device page being provided with a plurality of working mode buttons; and
when the working mode buttons are triggered, generating the control signals corresponding to the working mode buttons.

9. A control apparatus for a smart home, comprising:
an acquisition unit, configured to acquire weather information of a region where a terminal is located, and acquire state information of a target smart home from a smart home application, the smart home application being installed on the terminal;
a display unit, configured to synchronously display the state information of the target smart home and the weather information on a screen of the terminal;
a receiving unit, configured to receive a trigger signal generated on the basis of the state information and the weather information; and
a generation unit, configured to generate a control signal on the basis of the trigger signal, the control signal to control an operation state of the target smart home by means of the smart home application.

10. The control apparatus as claimed in claim 9, wherein the receiving unit comprises:
a receiving module, configured to receive a trigger signal acting on a switch button, switch buttons corresponding to the state information and the weather information being disposed in the screen of the terminal.

11. The control apparatus as claimed in claim 9, further comprising:
a determination unit, configured to determine state information of a target smart home before acquiring, from a smart home application, the target smart home in a smart home list, a plurality of smart homes being recorded in the smart home list, each smart home in the plurality of smart homes being associated with the smart home application.

12. The control apparatus as claimed in claim 11, wherein the determination unit comprises:
a display module, configured to display an application page of a weather application on the screen of the terminal, a synchronous start button being disposed on the application page;
an instruction generation module, configured to generate a synchronous start instruction, if it is detected that the synchronous start button is pressed, the synchronous start instruction to acquire the smart home list of the smart home application; and
a first determination module, configured to determine the selected target smart home in the smart home list.

13. The control apparatus as claimed in claim 11, wherein the determination unit comprises:
an acquisition module, configured to acquire a smart home list of the smart home application, after the weather application is started; and
a second determination module, configured to determine a plurality of smart homes recorded in the smart home list as the target smart home.

14. The control apparatus as claimed in claim 9, wherein the display unit comprises:
an information display module, configured to display the state information in a first region on the screen of the terminal, and display the weather information in a second region on the screen of the terminal.

15. The control apparatus as claimed in claim 14, wherein a management button corresponding to the target smart home is also disposed in the first region, and the control apparatus further comprises:
a jumping module, configured to jump to a management binding home page if it is detected that the management button is pressed after synchronously displaying the state information of the target smart home and the weather information on a screen of the terminal, the management binding home page being provided with a binding management button for modifying a synchronization state of the target smart home, the modification comprising initiating synchronization or canceling synchronization; and
an execution module, configured to execute an operation of modifying the synchronization state of the target smart home that indicated by the binding management button, when it is detected that the binding management button is pressed.

16. The control apparatus as claimed in claim 9, wherein
the receiving unit is configured to determine that the trigger signal generated in response to the operation is received, when it is detected that the state information of the target smart home is operated;
the generation unit comprises:
an entry module, configured to enter a device page of the target smart home, in response to the trigger signal, the device page being provided with a plurality of working mode buttons; and
a signal generation module, configured to generate the control signals corresponding to the working mode buttons, when the working mode buttons are triggered.
